(19) United States
(12) Patent Application Publication
(10) Pub. No.: US 2026/0222176 A1
(43) Pub. Date: Jul. 30, 2026

(54) STREAM PROCESSING FOR ENCRYPTED, INTEGRITY AND REPLAY-PROTECTED MEMORY

(71) Applicant: Rivos Inc., Santa C;ara, CA (US)

(72) Inventors: Ravi Sahita, Portland, OR (US); Neeraj Upasani, Sammamish, WA (US)

(21) Appl. No.: 19/144,828

(22) PCT Filed: Dec. 27, 2023
(86) PCT No.: PCT/US2023/086027

§ 371 Date: Jun. 30, 2025

Related U.S. Application Data
(60) Provisional application No. 63/477,926, filed on Dec. 30, 2022.

(51) Int. Cl. H04L 9/08

(52) U.S. Cl. CPC H04L 9/0816

(57) ABSTRACT

A processing system may include a memory device including a destination memory in communication with a memory encryption processing unit, wherein the memory encryption processing unit is configured to establish an authenticated-encrypted data stream with a host encryption processing unit via a communications channel by executing a mutual authentication protocol to establish a symmetric session key.

### CROSS-REFERENCE TO RELATED APPLICATION

This application claims priority to U.S. Patent Application No. 63/477,926, filed on Dec. 30, 2022, and entitled “STREAM PROCESSING FOR ENCRYPTED. INTEGRITY AND REPLAY-PROTECTED MEMORY,” the disclosure of which is incorporated by reference herein in its entirety.

### TECHNICAL FIELD

This description relates to providing a secure memory device for a microprocessor.

### BACKGROUND

A goal in microcontroller design is to provide security for information associated with workloads operating on the microcontroller while keeping some operations and other physical access outside the trusted computing base (TCB). To achieve this goal, cryptographic techniques are used to protect data that is exported from the TCB. Memory is one such device that is often accessed outside the TCB, including Random-Access Memory (RAM), for example.

Data sent to be saved outside the TCB is vulnerable to attack at the memory/TCB interface, however. When data is sent outside the TCB, confidentiality, integrity, and replay protection must be provided for the data. This is especially a concern in cloud computing, where clients send data to providers for storage and processing and want to be sure that data is secure from bad actors.

Prior methods for ensuring data integrity and confidentiality include using a first encryption key to encrypt data and a second encryption key to generate a message authentication code (MAC). Prior methods generate a large volume of metadata, in some cases 32 bits per 64 bytes of data protected, requiring additional memory storage and processor overhead to load and retrieve the metadata from memory. In addition, integrity check values must be generated on the data writes, and verified on memory reads. The versions of integrity values for subsequent writes to the same memory location must also be generated and tracked. As a result, metadata approaches to encrypting data have a heavy impact on performance. In some cases, metadata approaches can take as much as 20% in processor overhead to execute.

### SUMMARY

In some aspects, the techniques described herein relate to a processing system including: a memory device including a destination memory in communication with a memory encryption processing unit, wherein the memory encryption processing unit is configured to establish an authenticated-encrypted data stream with a host encryption processing unit via a communications channel by executing a mutual authentication protocol to establish a symmetric session key.

Implementations can include one or more of the following features, alone or in any combination with each other.

For example, the processing system can include a host computing device that includes the host encryption processing unit, where the host encryption processing unit is in communication with the memory encryption processing unit, and where the host encryption processing unit is configured to establish the authenticated-encrypted data stream in conjunction with the memory encryption processing unit.

In another example, the host encryption processing unit can include a first root of trust and the memory encryption processing unit can include a second root of trust.

In another example, the memory encryption processing unit can include a data parallel processor.

In another example, the data parallel processor can include a first processing element operable to send and receive data using the authenticated-encrypted data stream to the host encryption processing unit and a second processing element.

In another example, the second processing element can be operable to execute the mutual authentication protocol over a sideband channel.

In another example, the authenticated-encrypted data stream can use AES-GCM encryption, and the memory encryption processing unit can include an AES-GCM endpoint.

In another example, the destination memory can include a dual in line memory module.

In another example, the memory device can further include a high bandwidth memory in communication with the memory encryption processing unit.

In another example, the mutual authentication protocol can be a security protocol and data model mutual authentication.

In another example, the symmetric session key can be a first symmetric session key and, the memory encryption processing unit can be configured to, upon determining that a predetermined number of transactions have executed after the first symmetric session key was established, execute the mutual authentication protocol to establish a second symmetric session key, where the predetermined number of transactions is less than three hundred million transactions and a transaction includes a send operation or a receive operation over the authenticated-encrypted data stream.

In another example, the memory encryption processing unit can be further configured to read data from the destination memory and to send the data via the authenticated-encrypted data stream to the host encryption processing unit.

In another example, the data can include trusted compute encrypted data and the memory encryption processing unit can be further configured to decrypt the data read from the destination memory before the data is sent to the host encryption processing unit via the authenticated-encrypted data stream.

In another example, the memory encryption processing unit can be further configured to: receive data from the host encryption processing unit via the authenticated-encrypted data stream, decrypt the data received from the host encryption processing unit using the symmetric session key, and save the data in the destination memory.

In another example, the memory encryption processing unit can include a hardware private key, and saving the data in the destination memory can further include encrypting the data using a trusted compute function and the hardware private key before the data is saved to the destination memory.

In another example, the memory encryption processing unit can be further configured to: receive a math command from the host encryption processing unit via the authenticated-encrypted data stream, the math command being associated with a math operation and destination memory data, read destination memory data from the destination memory, decrypt the destination memory data using a trusted compute function and a hardware private key to generate decrypted destination memory data, and execute the math operation on the decrypted destination memory data to generate a math operation output.

In another example, the memory encryption processing unit can be further configured to send the math operation output to the host encryption processing unit via the authenticated-encrypted data stream.

In another example, the memory encryption processing unit can be connected to the destination memory via a memory link, and the memory link can include a housing enclosing a circuitry with tamper-resistant features, the tamper-resistant features being operable to destroy the circuitry if the housing is removed to expose the circuitry.

In some aspects, the techniques described herein relate to a method that includes: establishing, via a memory encryption processing unit, an authenticated-encrypted data stream via a communications channel with a host encryption processing unit by executing a mutual authentication protocol to establish a symmetric session key, where the memory encryption processing unit is part of a memory device including a destination memory in communication with the memory encryption processing unit.

Implementations can include one or more of the following features, alone or in any combination with each other.

For example, the host encryption processing unit can be part of a host computing device, and the method can further include: establishing, via the host encryption processing unit, the authenticated-encrypted data stream in conjunction with the memory encryption processing unit.

In another example, the memory encryption processing unit can include a data parallel processor.

In another example, the data parallel processor can include a first processing element operable to send and receive data using the authenticated-encrypted data stream to the host encryption processing unit and a second processing element.

In another example, the second processing element can be operable to execute the mutual authentication protocol over a sideband channel.

In another example, the host encryption processing unit can include a first root of trust and the memory encryption processing unit includes a second root of trust.

In another example, the authenticated-encrypted data stream can use AES-GCM encryption, and the memory encryption processing unit can include an AES-GCM endpoint.

In another example, the destination memory is a dual in line memory module.

In another example, the memory device can further include a high bandwidth memory in communication with the memory encryption processing unit.

In another example, the mutual authentication protocol can be security protocol and data model mutual authentication.

In another example, the symmetric session key can be a first symmetric session key and the method can further includes: upon determining that a predetermined number of transactions have executed after the first symmetric session key was established, executing, via the memory encryption processing unit, the mutual authentication protocol to establish a second symmetric session key, where the predetermined number of transactions is less than three hundred million transactions and a transaction includes a send operation or a receive operation over the authenticated-encrypted data stream.

In another example, the method can further include: reading, via the memory encryption processing unit, data from the destination memory; and sending the data via the authenticated-encrypted data stream to the host encryption processing unit.

In another example, the data can include trusted compute encrypted data and the method can further include: decrypting, via the memory encryption processing unit, the data read from the destination memory before the data is sent to the host encryption processing unit via the authenticated-encrypted data stream.

In another example, the method can further include: receiving, via the memory encryption processing unit, data from the host encryption processing unit via the authenticated-encrypted data stream; decrypting the data received from the host encryption processing unit using the symmetric session key; and saving the data in the destination memory.

In another example, the memory encryption processing unit can include a hardware private key, and saving the data in the destination memory can further include encrypting the data using a trusted compute function and the hardware private key before the data is saved to the destination memory.

In another example, the method can further include: receiving a math command from the host encryption processing unit via the authenticated-encrypted data stream, the math command being associated with a math operation and destination memory data, reading destination memory data from the destination memory, decrypting the destination memory data using a trusted compute function and a hardware private key to generate decrypted destination memory data, and executing the math operation on the decrypted destination memory data to generate a math operation output.

In another example, the method can further include sending the math operation output to the host encryption processing unit via the authenticated-encrypted data stream.

In another example, the memory encryption processing unit can be connected to the destination memory via a memory link, and the memory link can include a housing enclosing a circuitry with tamper-resistant features, where the tamper-resistant features is operable to destroy the circuitry if the housing is removed to expose the circuitry.

### BRIEF DESCRIPTION OF THE DRAWINGS

FIG. 1 depicts an example processing system.

FIG. 2A depicts an example processing system, according to examples described throughout this disclosure.

FIG. 2B depicts an example processing system, according to examples described throughout this disclosure.

FIG. 2C depicts an example processing system, according to examples described throughout this disclosure.

FIG. 3A depicts an example method, according to examples described throughout this disclosure.

FIG. 3B depicts an example method, according to examples described throughout this disclosure.

FIG. 3C depicts an example method, according to examples described throughout this disclosure.

FIG. 4A depicts an example flowchart of a process, according to examples described throughout this disclosure.

FIG. 4B depicts an example flowchart of a process, according to examples described throughout this disclosure.

### DETAILED DESCRIPTION

The present disclosure describes a memory device that includes a destination memory and memory encryption processing unit that can form an authenticated-encrypted data stream in conjunction with a host computing device. The authenticated-encrypted data stream provides data integrity, confidentiality, and replay protection for data between the trusted computing base (TCB) of the host computing device and the memory encryption processing unit. The inline memory encryption and decryption functions provided by the memory encryption processing unit also provide an improved, efficient data processing path for data encryption functions.

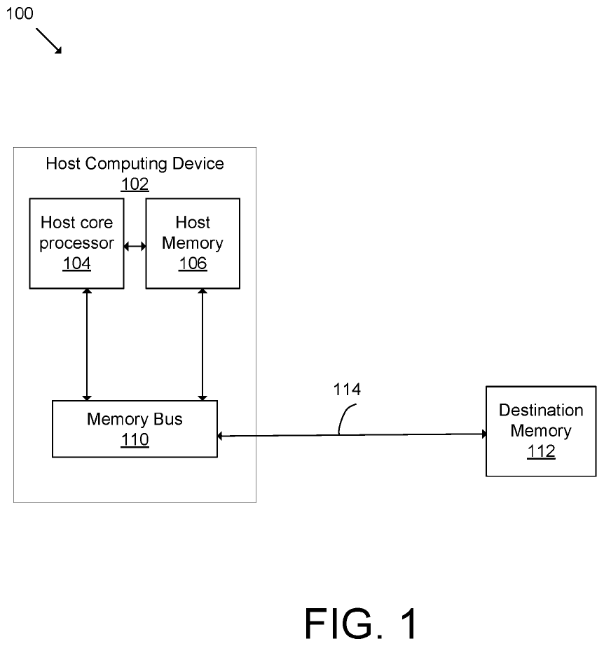

FIG. 1 depicts a processing system 100 that includes a host computing device 102 and a destination memory 112. Host computing device 102 includes at least a host core processor 104 in communication with host memory 106 and a memory bus 110. In some examples, host computing device 102 may include a desktop computer, a tablet computer, a laptop computer, a handheld device such as a tablet computer, a smart phone, a server, a workstation, and IOT type device, or any other computing device. In some examples, host computing device 102 may include a system-on-a-chip (SoC). In some examples, host computing device 102 may include an internet protocol device, a digital camera, an internet of things (IoT) device, an embedded device, a digital signal processor (DSP), a network computer, a set-top box, a network hub, a wide area network (WAN) switch, or any other system that can perform one or more instructions in accordance with techniques disclosed herein.

In some examples, host core processor 104 may include a CPU, a GPU, or any other microprocessor or microcontroller. In some examples, host core processor 104 may include a multicore processor or multiple processing units. In some examples, an operating system and/or applications may run on host core processor 104. Host core processor 104 executes instructions that may add secured pages to a protected region of memory, as guided by software executing on host core processor 104. When a cache line belonging to a secure page is evicted, host core processor 104 must provide the protections of data integrity and confidentiality for the cache line data as it leaves the trusted computing base (TCB) boundary of host computing device 102 to be stored at destination memory 112.

In some examples, host memory 106 may include CPU cache memory. Host memory 106 is in communication with host core processor 104. In some examples, host memory 106 may also be in communication with memory bus 110. In one example, host memory 106 may include a level 1 internal cache memory. In further examples however, host memory 106 may be configured to include any other configuration of cache memory. Depending on the architecture, host core processor 104 may have a single internal cache or multiple levels of internal caches. Other examples may include a combination of both internal and external caches.

Host computing device 102 includes memory bus 110. Memory bus 110 may be operable to transmit data signals between host core processor 104 and other components in processing system 100, such as destination memory 112. In some examples, memory bus 110 may support double data rate (DDR) data transfers to and from destination memory 112. In some examples, memory bus 110 may support computer express link (CXL) data transfers, for example using the CXL 3 protocol, to and from destination memory 112. In some examples, the processor bus may allow any type of data transfer protocol between host computing device 102 and destination memory 112, or any possible combination thereof.

Destination memory 112 is operable to store instructions and/or data saved by host core processor 104. Destination memory 112 is located outside the TCB of host computing device 102, in communication with memory bus 110. In some examples, destination memory 112 may include a dynamic random access memory (DRAM) device, a static random access memory (SRAM) device, a flash memory device, or any other suitable memory device.

Processing system 100 further includes communications channel 114 that facilitates communications between memory bus 110 and destination memory 112. Data sent from host core processor 104 to destination memory 112 is encrypted with a first key.

The simplified block diagram view of processing system 100 provided by FIG. 1 is not intended to be limiting. In some examples, host core processor 104 may include a reduced instruction set computing (RISC) microprocessor, a complex instruction set computer (CISC) microprocessor, a very long instruction word (VLIW) microprocessor, a processor implementing a combination of instruction sets, or any other processor device, such as a signal processor, for example. Further components of processing system 100 may include a graphics accelerator, a memory controller hub, and I/O controller hub, wireless receiver, a flash BIOS, network controller, an audio controller, a serial expansion port, and I/O controller, etc.

Previous methods for ensuring data integrity and confidentiality for data written to destination memory 112 by host computing device 102 included using a first key to encrypt data and a second key to generate a MAC. These techniques generate a large quantity of metadata that must be managed by host computing device 102. The additional memory storage and processor overhead required to load and retrieve the metadata from memory, generate integrity check values on data writes, verify on memory reads, and generate and track versions of integrity values for subsequent writes to the same memory location impacts host core processor 104 performance negatively.

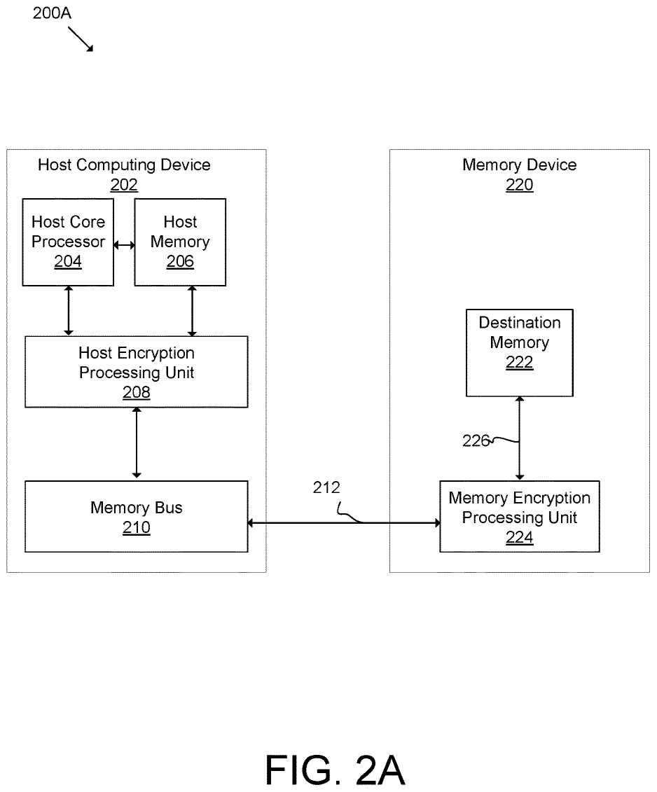

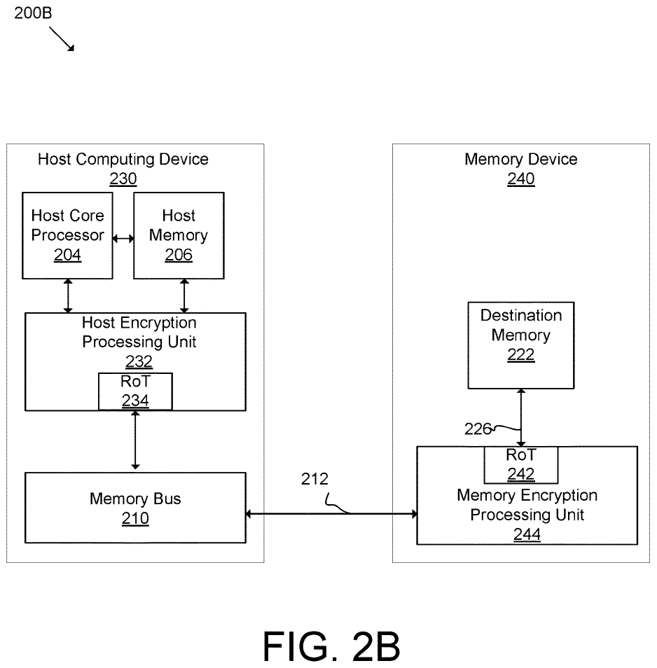

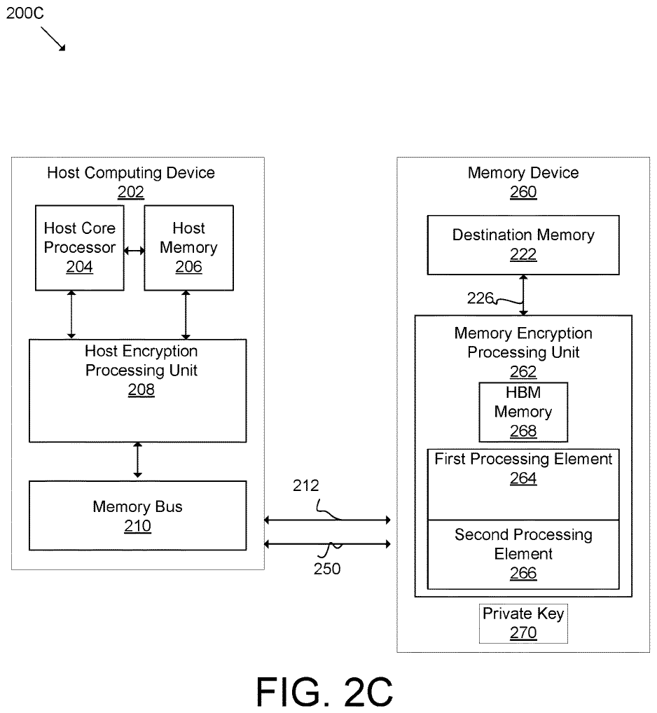

FIG. 2A depicts processing system 200A that includes a host computing device 202 and a memory device 220.

Memory device 220 includes a destination memory 222 in communication with a memory encryption processing unit 224. Destination memory 222 is operable to store any instructions and/or data saved by host core processor 104. Memory device 220 is located outside the TCB of host computing device 202. In an example, the destination memory 222 may include a dual in-line memory module (DIMM). In other examples, however, destination memory 222 may include any DRAM, SRAM, flash memory, or any other type of memory device.

Memory encryption processing unit 224 is configured to establish an authenticated-encrypted data stream with host encryption processing unit 208 over communications channel 212 by executing a mutual authentication protocol to establish a session key (e.g., a symmetric key, a secret key).

The authenticated-encrypted data stream may use any protocol allowing host encryption processing unit 208 and memory encryption processing unit 224 to each authenticate, for example establish, or negotiate, secure communications in conjunction with each other (i.e., in combination with, in collaboration with, together with each other) using an encryption key, and then to encrypt and decrypt data so that the data may be sent securely over communications channel 212. After establishing the authenticated-encrypted data stream, memory encryption processing unit 224 is operable to receive encrypted data from host computing device 202 and decrypt that data, or to encrypt data and send the encrypted data to host computing device 202.

The encryption and decryption processes use the established symmetric session key and a private key known only to memory encryption processing unit 224 as well. In some examples, the private key may be a physical unclonable function (PUF).

Memory encryption processing unit 224 is also operable to facilitate reading and writing data to destination memory 222.

By executing a mutual authentication protocol and enabling the sending and receiving of encrypted data over an authenticated-encrypted data stream, memory encryption processing unit 224 may serve as an inline cryptographic accelerator.

Communications channel 212 includes a data connection between host computing device 202 and memory device 220 via memory bus 110.

Host computing device 202 includes host encryption processing unit 208. In some examples, host computing device 202 may further include host core processor 204, host memory 206 and a memory bus 210. In some examples, host computing device 202 may further include a host memory 206, similar to host memory 106 described with respect to host computing device 102.

Host encryption processing unit 208 is configured to establish an authenticated-encrypted data stream with memory encryption processing unit 224. Similar to memory encryption processing unit 224, host encryption processing unit 208 is configured to authenticate secure communication using an encryption key, encrypt, and decrypt data so that it may be sent securely over communications channel 212. In some examples, the functionality discussed with regards to host encryption processing unit 208 may be incorporated into host core processor 204.

In some examples, host encryption processing unit 208 and memory encryption processing unit 224 may execute security protocol and data model (SPDM) authentication that may allow host encryption processing unit 208 and memory encryption processing unit 224 to verify the identity of a symmetric session key and set up a secure session for the data path keys. In some examples, host encryption processing unit 208 and memory encryption processing unit 224 may execute a PKI authentication or a Diffie-Helman authentication to verify the symmetric session key. In other examples, host encryption processing unit 208 and memory encryption processing unit 224 may execute any other type of authentication protocol suitable to verify the identity of the symmetric session key.

In some examples, the authenticated-encrypted data stream may use AES-GCM encryption, and memory device 220 may include an AES-GCM endpoint. In some examples, the AES-GCM endpoints may be integrated or hardened into memory. For example, the AES-GCM endpoint may include a hardware private key. In some examples, other end-to-end or socket-to-socket encryption protocols are also possible, using other endpoints or private keys. In some examples, a hardware private key may include a PUF. In some examples, an AES-GCM endpoint or a hardware public key may be integrated into the memory access path such that any tamper of the circuit renders destination memory 222 inaccessible. The hardware private key may be hardened into memory using any method.

In some examples, memory encryption processing unit 224 may be further configured to execute one or more trusted compute functions on data to generate trusted compute encrypted data. In some examples, the trusted compute functions may rely on a pair of public and private keys that are only accessible to memory encryption processing unit 224. In some examples, the private key may be a hardware private key. In some examples, the one or more trusted compute functions may include any combination of compressing, hashing, inspecting for patterns, measuring integrity, performing cryptographic functions on the data, vector operations, matrix operations, single instruction multiple data (SIMD) operations, single instruction multiple thread (SIMT) operations, or multiple instruction, multiple thread (MIMT) operations. By executing one or more trusted compute functions, memory encryption processing unit 224 may encrypt data before saving on destination memory 222, thereby improving the security of data saved on memory device 220. By executing trusted compute functions on memory encryption processing unit 224 instead of on host computing device 202, 230, memory encryption processing unit 224 may provide security for data saved on destination memory 222 without using processor bandwidth and memory on host computing device 202, 230. In this way, memory encryption processing unit 224 may act as an encryption accelerator. Executing trusted compute functions on memory encryption processing unit 224 may also reduce data transmission across communications channel 212, thereby reducing host latency and improving security by eliminating additional opportunities to intercept data passing through communications channel 212.

In some examples, the memory encryption processing unit 224 may be configured to execute one or more math operations. For example, memory encryption processing unit 224 may be configured to receive a math command from host encryption processing unit 208 via the authenticated-encrypted data stream. The math command may be associated with a math operation and destination memory data. In examples, the math command may include one or more destination memory data addresses for the destination memory data. Memory encryption processing unit 224 may then read destination memory data from destination memory 222, decrypt the destination memory data using a trusted compute function and a hardware private key to generate decrypted destination memory data. Next memory encryption processing unit 224 may perform the math operation on the decrypted destination memory data to generate a math operation output. In examples, the memory encryption processing unit 224 may then send the math operation output to host encryption processing unit 208 via the authenticated-encrypted data stream. In other examples, the math operation output may be written to destination memory 222. In this way, memory encryption processing unit 224 may act as a math accelerator.

FIG. 2B depicts a processing system 200B, in accordance with an example of the disclosure. Processing system 200B depicts an example host computing device 230 and a memory device 240.

Host computing device 230 may be similar to host computing device 202, with the exception that host computing device 230 includes a host encryption processing unit 232. Host encryption processing unit 232 may include much of the functionality described with respect to host encryption processing unit 208, with the inclusion of a root of trust (RoT) 234. RoT 234 includes cryptographic keys rooted in the hardware of a device that help the device establish a unique identity. In some examples, RoT 234 may include a hardware private key. In some examples, RoT 234 may perform data encryption and decryption, certificate validation and key management. In some examples. RoT 234 may include a hardware RoT, silicon-based RoT, a programmable RoT, or a combination thereof.

Memory device 240 may be similar to memory device 220, with the exception that memory device 220 includes a memory encryption processing unit 244. Memory encryption processing unit 244 may include much of the functionality described with respect to memory encryption processing unit 224 above, with the additional inclusion of a RoT 242. RoT 242 may include any of the features described with regards to RoT 234, as described above.

In some examples, memory encryption processing unit 224, 244 may be configured to receive encrypted data from host encryption processing unit 208, 232 via an authenticated-encrypted data stream, decrypt the data, and save the data in destination memory 222.

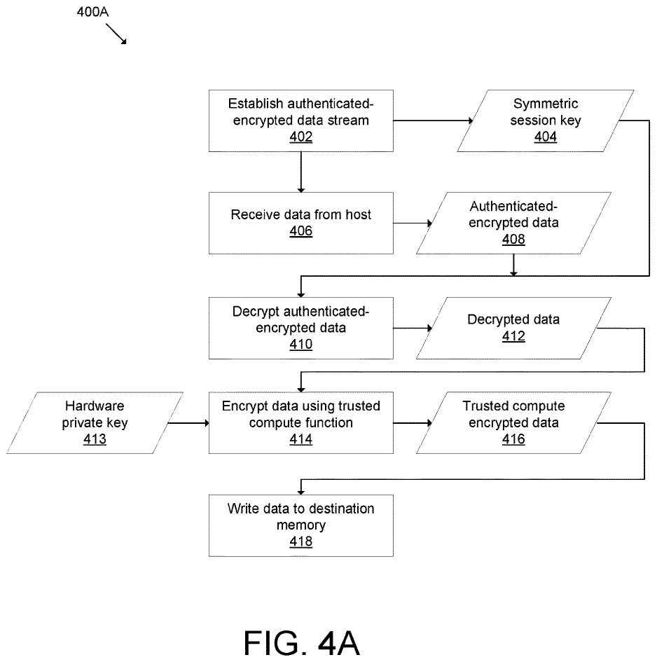

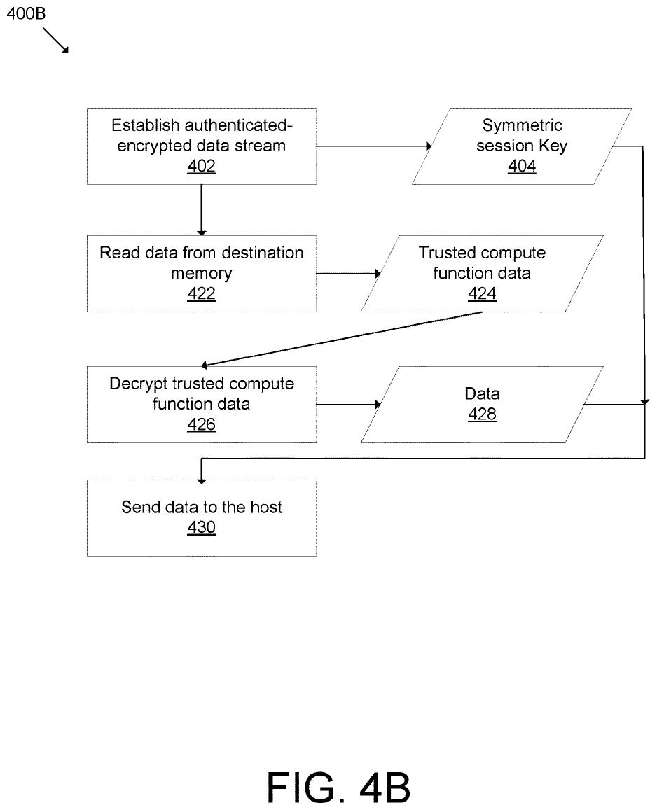

For example. FIG. 4A depicts a flowchart of a process 400A, in accordance with an example. Process 400A begins with establishing an authenticated-encrypted data stream (block 402), as described above with respect to memory encryption processing unit 224, which generates a symmetric session key 404. As described above, symmetric session key 404 may be used to encrypt and decrypt data sent between host computing device 202 and memory device 220.

Process 400A continues with receiving data from host (block 406), where memory encryption processing unit 224 receives authenticated-encrypted data 408. Authenticated-encrypted data 408 may be encrypted by host encryption processing unit 208 or 232 using symmetric session key 404.

Process 400A continues with decrypting authenticated-encrypted data (block 410). Block 410 receives symmetric session key 404 and authenticated-encrypted data 408 and generates decrypted data 412. In some examples, decrypted data 412 may include cache data. In some examples, decrypted data 412 may include any other type of data.

In some examples, process 400A may continue with encrypting data using a trusted compute function (block 414), which can include receiving decrypted data 412 and hardware private key 413 and generating trusted compute encrypted data 416, as described above.

Process 400A may continue with writing data to destination memory (block 418). In the depiction of process 400A, it is represented that trusted compute encrypted data 416 is received at block 418. However, as noted above, block 418 may alternatively receive decrypted data 412 for writing to destination memory 222.

In some examples, data may be read from destination memory 222 and sent via the authenticated-encrypted data stream to host encryption processing unit 208, 232. In some examples, memory encryption processing unit 224, 244 may be further configured to decrypt the data read from destination memory 222 before the data is sent to host encryption processing unit 208, 232.

For example, FIG. 4B depicts a flowchart of a process 400B, in accordance with an example. Process 400B begins with establishing an authenticated-encrypted data stream (block 402), which generates symmetric session key 404, as described above.

Process 400B continues with reading data from destination memory (block 422), which generates data. In examples where unencrypted data is saved on destination memory 222, block 422 may generate data 428 directly without executing block 426, with data 428 not being encrypted. In further examples where encrypted data is saved on destination memory 222, however, block 422 may generate trusted compute function data 424. In the case that block 422 generates trusted compute function data 424, process 400B may continue with decrypting trusted compute function data (block 426), as depicted in FIG. 4B. Block 426 receives trusted compute function data 424 and generates data 428, which is unencrypted.

Process 400B continues with sending data to the host (block 430). Block 430 receives data 428 and symmetric session key 404, encrypts data 428 with symmetric session key 404, and sends encrypted data to host computing device 202, 230 via the authenticated-encrypted data stream, as described above.

In some examples, symmetric session key 404 may be a first symmetric session key and, upon determining that a predetermined number of transactions have executed after the first symmetric session key was established, memory encryption processing unit 224, 244 may be configured to execute the mutual authentication protocol to establish a second symmetric session key. A transaction may include a send operation or a receive operation over the authenticated-encrypted data stream. In some examples, the predetermined number of transactions may be less than three hundred million transactions. In some examples, the predetermined number of transactions may be less than one hundred million transactions. In some examples, the predetermined number of transactions may be as few as one transaction.

Replay attacks occur when a bad actor repeats or delays a data transmission sent by an authorized user to gain access to or affect the behavior of the recipient. By refreshing symmetric session key 404 used in the authenticated-encrypted data stream at a high rate, it may be possible to reduce the risk of replay attacks on processing system 200A, 200B. In prior processing systems, encryption keys are created and stored on the host computing device 202. In order to refresh an encryption key in prior systems, it is necessary to read all data into a memory, re-encrypt it with a new encryption key, and then rewrite the encrypted data to memory. Using the ephemeral authenticated-encrypted data stream described in this disclosure provides additional security using substantially less memory and host processor cycles.

FIG. 2C depicts a processing system 200C, in accordance with an example of the disclosure. Processing system 200C depicts a host computing device 202 and a memory device 260.

Memory device 260 includes a memory encryption processing unit 262 in communication with destination memory 222.

In some examples, memory encryption processing unit 262 may include a data parallel processor, or a data processing unit (DPU). In some examples, memory encryption processing unit 262 may comprise a GPU chiplet with one or more processing elements. In some examples, a GPU chiplet may include a multiprocessor core on a fabric. Using a data parallel processor may allow memory encryption processing unit 262 to operate as a data parallel accelerator. Configuring memory encryption processing unit 262 as a data parallel engine may allow for improved energy efficiency (performance per watt) of processing and/or reduced usage of the memory link by avoiding data reads and writes to host core processor 204.

In some examples, the parallel processor may include a first processing element 264 operable to send and receive data using the authenticated-encrypted data stream to the host encryption processing unit 208 and a second processing element 266. First processing element 264 and second processing element 266 may be connected via a fabric, such as a system on a chip fabric.

In some examples, second processing element 266 may be operable to execute the mutual authentication protocol. In some examples, second processing element 266 may execute the mutual authentication protocol over an additional channel, a sideband channel 250. Sideband channel 250 may provide an additional communications path beyond communications channel 212 for memory encryption processing unit 262 to communicate with host encryption processing unit 208. Sideband channel 250 and second processing element 266 may therefore provide a sideband interface to bootstrap the authentication process. In some examples, sideband channel 250 may be used to execute SPDM mutual authentication. Sideband channel 250 may therefore provide a low-cost way to simplify the boot process for processing system 200C. In some examples, memory device 220 or 240 may include sideband channel 250 to execute the mutual authentication protocol as well.

In some examples, memory device 260 may further include a high bandwidth memory, HBM 268. HBM 268 may be included within memory encryption processing unit 262, or in communication with memory encryption processing unit 262. HBM 268 may be used to provide faster caching as memory encryption processing unit 262 encrypts or decrypts data. HBM 268 may help memory device 260 serve as an accelerator for cryptography operations. In some examples, memory device 220 or 240 may include HBM 268 as well.

In some examples, host encryption processing unit 208 and memory encryption processing unit 262 may each further include a RoT (not pictured in FIG. 2C). In some examples, host computing device 202 may include any of the features described with regards to host computing device 230, and memory devices 220 or 240 may include any of the features described with regards to memory device 260.

In some examples, decrypted data may be written by memory encryption processing unit 224, 244, or 262 to destination memory 222. Memory link 226, which connects memory encryption processing unit 224, 244, 262 and destination memory 222 in hardware could therefore be a target for tampering from a hacker.

Memory link 226 may include a housing enclosing a circuitry. In some examples, the circuitry may include one or more traces or wires used to communicatively connect memory encryption processing unit 224, 244, or 262 and destination memory 222. The housing may include layers of integrated circuit (IC) substrate. In some examples, the housing may include any special purpose housing material. In some examples, the housing may include components of a connector.

In some examples, memory link 226 may therefore include physical protection. For example, memory link 226 may include tamper-resistant features operable to destroy the circuitry if the housing is removed to expose the circuitry. The tamper-resistant features may ensure that, should the packaging around the circuitry of memory link 226 be opened, fully or partially removed, or etched away, the tamper-resistant features will ensure that memory link 226 circuitry is destroyed or damaged, making it impossible to read destination memory 222 through memory link 226. In some examples, the tamper-resistant features may include a housing with hard to remove material strongly bonded to memory link 226 circuitry so that if the housing is tampered with the underlying circuitry will also be destroyed. In some examples, the circuitry may include a chemical component that destroys the circuitry if it is exposed to ambient air because the packaging is removed. In some examples, other tamper-resistant features for memory link 226 are also contemplated.

In some examples, the data stored on destination memory 222 may alternatively be protected from hacking by using trusted compute functions. The trusted compute functions may provide encryption using hardware private key 270. In examples, physically accessing hardware private key 270 may destroy it, rendering the encrypted data stored on destination memory 222 inaccessible.

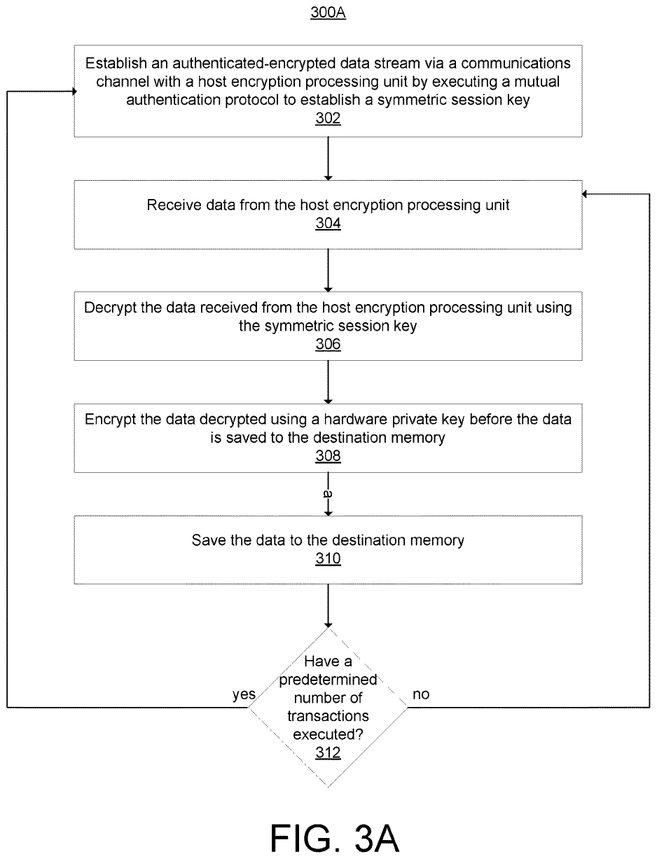

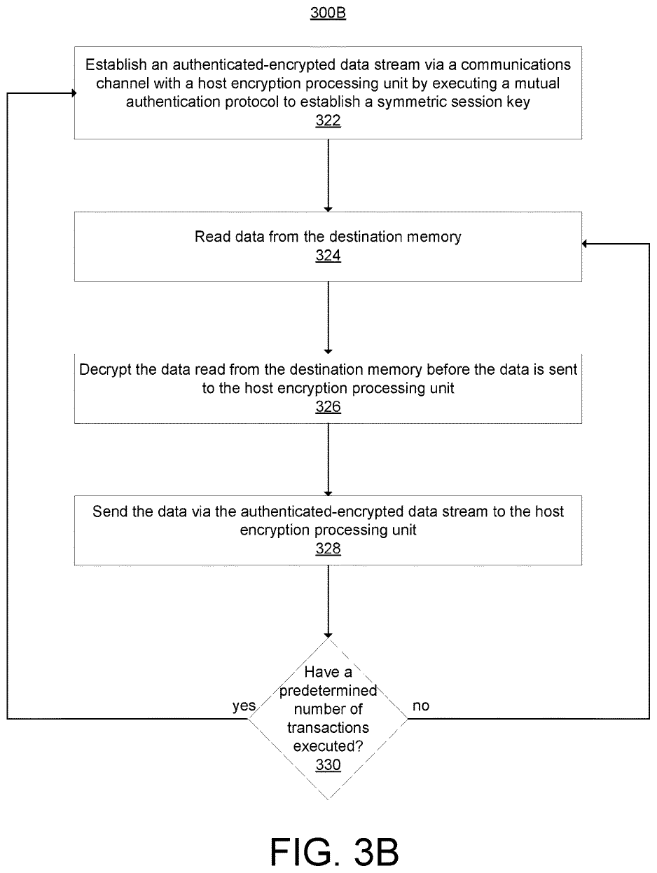

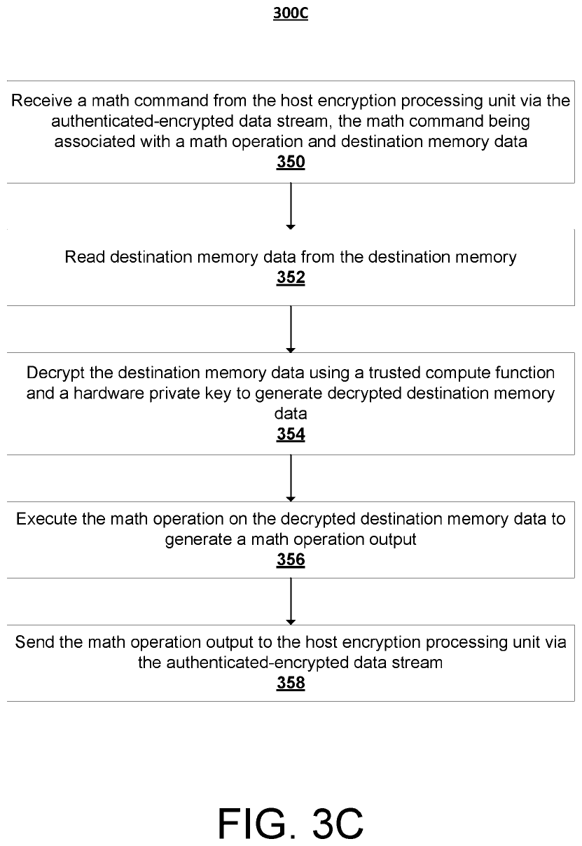

FIG. 3A depicts a flowchart of a method 300A in accordance with an example. Method 300A may be executed by memory encryption processing unit 224, 244, 262. Method 300A is operable to establish an authenticated-encrypted data stream, receive data from host computing device 202, 230, to decrypt the data, and save the data to destination memory 222. In some examples, method 300A may include any combination of steps 302 to 312.

Method 300A begins with step 302. In step 302, an authenticated-encrypted data stream is established via communications channel 212 with host encryption processing unit 208, 232 by executing a mutual authentication protocol to establish symmetric session key 404, as described above.

Method 300A may continue with step 304. In step 304, data is received from host encryption processing unit 208, 232, as described above.

Method 300A may continue with step 306. In step 306, the data received from host encryption processing unit 208, 232 is decrypted using symmetric session key 404.

Method 300A may continue with step 308. In step 308, the data decrypted using a hardware private key 413 may be encrypted before the data is saved to destination memory 222. For example, data received in and decrypted by memory encryption processing unit 224, 244, 262 may be re-encrypted using a trusted compute function before saving the data to destination memory 222, as described above.

Method 300A may continue with step 310. In step 310, the data may be saved to destination memory 222, as described above.

Method 300A may continue with step 312. In step 312, it may be determined whether a predetermined number of transactions have executed, as described above. In some examples, the predetermined number of transactions may include 300 million transactions. If step 312 evaluates yes, method 300A may continue with step 302. If step 312 evaluates no, however, then method 300A may continue with step 304.

FIG. 3B depicts a flowchart of a method 300B, in accordance with an example. Method 300B may be executed by memory encryption processing unit 224, 244, 262. Method 300B is operable to establish an authenticated-encrypted data stream, read data from destination memory 222, and send the data via the authenticated-encrypted data stream to host encryption processing unit 208, 232. In some examples, method 300B may include any combination of steps 322 to 330.

Method 300B begins with step 322. Step 322 is the same as 302 described above.

Method 300B may continue with step 324. In step 324, data may be read from destination memory 222, as described above.

Method 300B may continue with step 326. In step 326, data read from destination memory 222 may be decrypted before the data is sent to host encryption processing unit 208, 232, as described above.

Method 300B may continue with step 328. In step 328, the data may be sent via the authenticated-encrypted data stream to host encryption processing unit 208, 232, as described above.

Method 300B may continue with step 330. In some examples, step 330 may be similar to step 312, described above. If step 330 evaluates yes, method 300B may continue with step 322. If step 330 evaluates no, however, then method 300B may continue with step 324.

FIG. 3C depicts a flowchart of a method 300C, in accordance with an example. Method 300C may be executed by memory encryption processing unit 224, 244, 262. Method 300C is operable to execute math operations at the command of host encryption processing unit 208, 232.

Method 300C begins with step 350. In step 350, a math command may be received from host encryption processing unit 208, 232 via the authenticated-encrypted data stream, the math command being associated with a math operation and destination memory data, as described above.

In examples, method 300C may continue with step 352. In step 352, destination memory data may be read from destination memory 222, as described above.

In examples, method 300C may continue with step 354. In step 354, the destination memory data may be decrypted using a trusted compute function and a hardware private key to generate decrypted destination memory data, as described above.

In examples, method 300C may continue with step 356. In step 356, the math operation may be executed on the decrypted destination memory data to generate a math operation output, as described above.

In examples, method 300C may continue with step 358. In step 358, the math operation output may be sent to host encryption processing unit 208, 232 via the authenticated-encrypted data stream, as described above.

In examples, method 300C may encrypt the math operation output using a trusted compute function before saving the math operation output data to destination memory 222. In examples, the math operation output data may be encrypted and saved to destination memory 222 in addition to, or instead of executing step 358.

The disclosure describes a method and processing system that provide improved data security when writing data to memory outside a TCB. By establishing an authenticated-encrypted data stream between a host computing device and a memory device, it is possible for the host to avoid the processing and memory overhead required by prior data security approaches that use metadata to store generated integrity check values for memory cache lines. This may provide for improved, and more efficient use of, storage space processing cycles within the host computing device, freeing the host processor to execute other tasks. By moving the trusted computing base cryptographic processing to a memory encryption processing unit that is positioned inline between the host computing device and a destination memory on a memory device, it is possible to use the memory device as a cryptographic accelerator providing a more efficient data processing path, and further secure the data saved in the destination memory. By providing an authenticated-encrypted data stream between the host computing device and the memory device that can renegotiate a mutual key at a predetermined or programmable frequency, it is also possible to provide improved data integrity, confidentiality, in addition to security against side-channel and replay attacks. By providing a memory link housing on the memory device that includes tamper-resistant features, it is possible to further secure the data saved in the destination memory. By providing a memory encryption processing unit that can perform math operations, it is possible to use memory device 260 as a math accelerator, further freeing up processor cycles within host computing device 202 while still executing the math operations within a trusted computing location.

Various examples of the systems and techniques described here can be realized in digital electronic circuitry, integrated circuitry, specially designed ASICs (application specific integrated circuits), computer hardware, firmware, software, and/or combinations thereof. These various examples can include examples in one or more computer programs that are executable and/or interpretable on a programmable system including at least one programmable processor, which may be special or general purpose, coupled to receive data and instructions from, and to transmit data and instructions to, a storage system, at least one input device, and at least one output device. Various examples of the systems and techniques described here can be realized as and/or generally be referred to herein as a circuit, a module, a block, or a system that can combine software and hardware aspects. For example, a module may include the functions/acts/computer program instructions executing on a processor or some other programmable data processing apparatus.

Some of the above examples are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing examples. Examples, however, may be embodied in many alternate forms and should not be construed as limited to only the examples set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example examples. As used herein, the term and/or includes any and all combinations of one or more of the associated listed items.

The terminology used herein is for the purpose of describing particular examples only and is not intended to be limiting of example examples. As used herein, the singular forms a, an, and the are intended to include the plural forms as well, unless the context clearly indicates otherwise. It will be further understood that the terms include, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative examples, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example examples belong. It will be further understood that terms. e.g., those defined in commonly used dictionaries, should be interpreted as having a meaning that is consistent with their meaning in the context of the relevant art and will not be interpreted in an idealized or overly formal sense unless expressly so defined herein.

Portions of the above example examples and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative examples, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be bome in mind, however, that all of these and similar terms are to be associated with the appropriate physical quantities and are merely convenient labels applied to these quantities. Unless specifically stated otherwise, or as is apparent from the discussion, terms such as processing or computing or calculating or determining or displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example examples are typically encoded on some form of non-transitory program storage medium or implemented over some type of transmission medium. Similarly, the transmission medium may be twisted wire pairs, coaxial cable, optical fiber, or some other suitable transmission medium known to the art. The examples are not limited by these aspects of any given examples.

Lastly, it should also be noted that whilst the accompanying claims set out particular combinations of features described herein, the scope of the present disclosure is not limited to the particular combinations hereafter claimed, but instead extends to encompass any combination of features or examples herein disclosed irrespective of whether or not that particular combination has been specifically enumerated in the accompanying claims at this time.

1. A processing system comprising:
a memory device including a destination memory in communication with a memory encryption processing unit,
wherein the memory encryption processing unit is configured to establish an authenticated-encrypted data stream with a host encryption processing unit via a communications channel by executing a mutual authentication protocol to establish a symmetric session key.

2. The processing system of claim 1, further comprising:
a host computing device including the host encryption processing unit, the host encryption processing unit being in communication with the memory encryption processing unit,
wherein the host encryption processing unit is configured to establish the authenticated-encrypted data stream in conjunction with the memory encryption processing unit.

3. The processing system of claim 2, wherein the host encryption processing unit comprises a first root of trust and the memory encryption processing unit comprises a second root of trust.

4. The processing system of claim 2, wherein the memory encryption processing unit comprises a data parallel processor.

5. The processing system of claim 4, wherein the data parallel processor includes a first processing element operable to send and receive data using the authenticated-encrypted data stream to the host encryption processing unit and a second processing element.

6. The processing system of claim 5, wherein the second processing element is operable to execute the mutual authentication protocol over a sideband channel.

7. The processing system of claim 1, wherein the authenticated-encrypted data stream uses AES-GCM encryption, and the memory encryption processing unit comprises an AES-GCM endpoint.

8. The processing system of claim 1, wherein the destination memory is a dual in-line memory module.

9. The processing system of claim 1, wherein the memory device further comprises a high bandwidth memory in communication with the memory encryption processing unit.

10. (canceled)

11. The processing system of claim 1, wherein the symmetric session key is a first symmetric session key and, wherein the memory encryption processing unit is configured to, upon determining that a predetermined number of transactions have executed after the first symmetric session key was established, execute the mutual authentication protocol to establish a second symmetric session key, wherein the predetermined number of transactions is less than three hundred million transactions and a transaction comprises a send operation or a receive operation over the authenticated-encrypted data stream.

12. The processing system of claim 1, wherein the memory encryption processing unit is further configured to read data from the destination memory and send the data via the authenticated-encrypted data stream to the host encryption processing unit.

13. The processing system of claim 12, wherein the data comprises trusted compute encrypted data and the memory encryption processing unit is further configured to decrypt the data read from the destination memory before the data is sent to the host encryption processing unit via the authenticated-encrypted data stream.

14. The processing system of claim 1, wherein the memory encryption processing unit is further configured to: receive data from the host encryption processing unit via the authenticated-encrypted data stream, decrypt the data received from the host encryption processing unit using the symmetric session key, and save the data in the destination memory.

15. The processing system of claim 14, wherein the memory encryption processing unit includes a hardware private key, and wherein saving the data in the destination memory further comprises encrypting the data using a trusted compute function and the hardware private key before the data is saved to the destination memory.

16. The processing system of claim 1, wherein the memory encryption processing unit is further configured to:
receive a math command from the host encryption processing unit via the authenticated-encrypted data stream, the math command being associated with a math operation and destination memory data,
read destination memory data from the destination memory,
decrypt the destination memory data using a trusted compute function and a hardware private key to generate decrypted destination memory data, and
execute the math operation on the decrypted destination memory data to generate a math operation output.

17. The processing system of claim 16, wherein the memory encryption processing unit is further configured to:
send the math operation output to the host encryption processing unit via the authenticated-encrypted data stream.

18. The processing system of claim 1, wherein the memory encryption processing unit is connected to the destination memory via a memory link, and the memory link includes a housing enclosing a circuitry with tamper-resistant features, the tamper-resistant features being operable to destroy the circuitry if the housing is removed to expose the circuitry.

19. A method comprising:
establishing, via a memory encryption processing unit, an authenticated-encrypted data stream via a communications channel with a host encryption processing unit by executing a mutual authentication protocol to establish a symmetric session key, wherein the memory encryption processing unit is part of a memory device including a destination memory in communication with the memory encryption processing unit.

20. (canceled)

21. (canceled)

22. (canceled)

23. (canceled)

24. (canceled)

25. (canceled)

26. (canceled)

27. (canceled)

28. (canceled)

29. (canceled)

30. The method of claim 19, further comprising:
reading, via the memory encryption processing unit, data from the destination memory; and
sending the data via the authenticated-encrypted data stream to the host encryption processing unit.

31. (canceled)

32. The method of claim 19, wherein the memory encryption processing unit includes a hardware private key:
receiving, via the memory encryption processing unit, data from the host encryption processing unit via the authenticated-encrypted data stream;
decrypting the data received from the host encryption processing unit using the symmetric session key; and
saving the data in the destination memory.

33. (canceled)

34. (canceled)

35. (canceled)

36. (canceled)
